(19) United States
(12) Patent Application Publication
(10) Pub. No.: US 2007/0191069 A1
(43) Pub. Date: Aug. 16, 2007

(54) Radio communication terminal device and radio communication function control method

(75) Inventor: Takashi Matsumoto, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 10/592,073

(22) PCT Filed: Mar. 9, 2005
(86) PCT No.: PCT/JP05/04090

§ 371 Date: Sep. 7, 2006

(30) Foreign Application Priority Data
Mar. 12, 2004 (JP) 2004-071618

(51) Int. Cl. H04B 1/16; H04B 1/38; H04M 1/00

(52) U.S. Cl. 455/566; 455/574; 455/343.1

(57) ABSTRACT

There are provided a radio communication terminal device and a radio communication function control method enabling a user to perform off-operation of only the mobile telephone function when the user is in a radio LAN area. In the device and the method, a radio dual terminal (100) is a radio communication terminal device having both of the communication function via a mobile telephone base station (101) of a mobile telephone system (mobile telephone function) and the communication function via a radio LAN base station (102) of the radio LAN system (radio LAN function). When the radio dual terminal (100) comes into the radio LAN area (104), a message asking whether to turn off the mobile telephone function appears on the display screen. If the user answers Yes, only the mobile telephone function is turned off, thereby reducing the power consumption when in the radio LAN area (104). It should be noted that when the radio dual terminal (100) goes out of the radio LAN area (104), the mobile telephone function which has been off is automatically turned on.

### TECHNICAL FIELD

The present invention relates to a radio communication terminal apparatus and radio communication function control method that have both a function for communication via a mobile phone system and a function for communication via a wireless LAN system.

### BACKGROUND ART

Mobile phones employ a variety of strategies for reducing power consumption in order to extend battery life. For example, in Patent Document 1 a mobile phone is disclosed that enables a user to be involved in processing that reduces power consumption by displaying a message inquiring whether or not an out-of-range indication is to be continued when the mobile phone has been out-of-range for a predetermined time or longer, or whether automatic startup is to be performed a predetermined time after power is turned off, and performing power-off control in accordance with the selection made by the user.

In recent years, with the increasingly widespread use of broadband communications, radio dual terminals have been developed that are provided with a function for communication via a broadband wireless LAN (hereinafter referred to as “wireless LAN function”) in addition to a function for communication via a mobile phone system (hereinafter referred to as “mobile phone function”). With demand for such radio dual terminals expected to grow, there is a need to devise a power consumption reduction strategy for these terminals. Patent Document 1: Japanese Patent Application Laid-Open No. 2002-208887

### DISCLOSURE OF INVENTION

### Problems to be Solved by the Invention

However, with a radio dual terminal, since the wireless LAN function can be used when a wireless LAN area is entered even when the terminal is within a mobile phone area, there are cases where the mobile phone function becomes unnecessary. In general, a wireless LAN communications zone is larger than a mobile phone communications zone, and a user will generally give precedence to the wireless LAN function when in a wireless LAN area configured on a spot basis. Therefore, in order to reduce power consumption in a radio dual terminal, a mechanism is necessary that enables only the mobile phone function to be turned off in a wireless LAN area, and automatically turns on the turned-off mobile phone function outside a wireless LAN area.

It is an object of the present invention to provide a radio communication terminal apparatus and radio communication function control method provided with a mechanism that enables a user to turn off only the mobile phone function when within a wireless LAN area, and automatically turns on the turned-off mobile phone function when the wireless LAN area has been exited.

### Means For Solving the Problems

A radio communication terminal apparatus of the present invention has both a mobile phone function that performs communication via a mobile phone system and a wireless LAN function that performs communication via a wireless LAN system, and employs a configuration comprising: a determination section that determines whether or not the terminal has entered a wireless LAN area; a display section that, when it is determined by the determination section that the terminal has entered a wireless LAN area, displays a message inquiring whether or not the mobile phone function is to be turned off; and a control section that places the mobile phone function in an off state or sleep state in response to a button operation in response to the inquiry display.

### Advantageous Effect of the Invention

According to the present invention, a mechanism is provided that enables a user to turn off only the mobile phone function, enabling power consumption to be reduced when within a wireless LAN area. Also, the turned-off mobile phone function is turned on automatically when the wireless LAN area is exited, enabling communication by means of the mobile phone function even outside a wireless LAN area.

### BRIEF DESCRIPTION OF DRAWINGS

FIG. 1 is a system diagram showing a sample configuration of a communication system in which a radio dual terminal according to one embodiment of the present invention is applied;

FIG. 2 is a block diagram showing the internal configuration of the radio dual terminal shown in FIG. 1 according to this embodiment;

FIG. 3 is a drawing showing a sample external configuration of the radio dual terminal shown in FIG. 1 according to this embodiment, and a sample inquiry message display prompting the user to perform an operation to turn off the mobile phone function; and

FIG. 4 is a flowchart that explains the radio communication function control operations of the radio dual terminal shown in FIG. 1 according to this embodiment.

### BEST MODE FOR CARRYING OUT THE INVENTION

An embodiment of the present invention will now be described in detail with reference to the accompanying drawings.

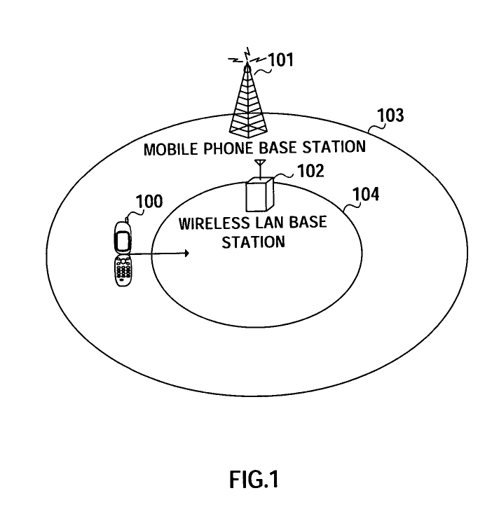

FIG. 1 is a system diagram showing a sample configuration of a communication system in which a radio dual terminal according to one embodiment of the present invention is applied. As shown in FIG. 1, a radio dual terminal 100 of the present invention is a radio communication terminal apparatus that has both a function for communication via a mobile phone base station 101 of a mobile phone system (a mobile phone function) and a function for communication via a wireless LAN base station 102 of a wireless LAN system (a wireless LAN function).

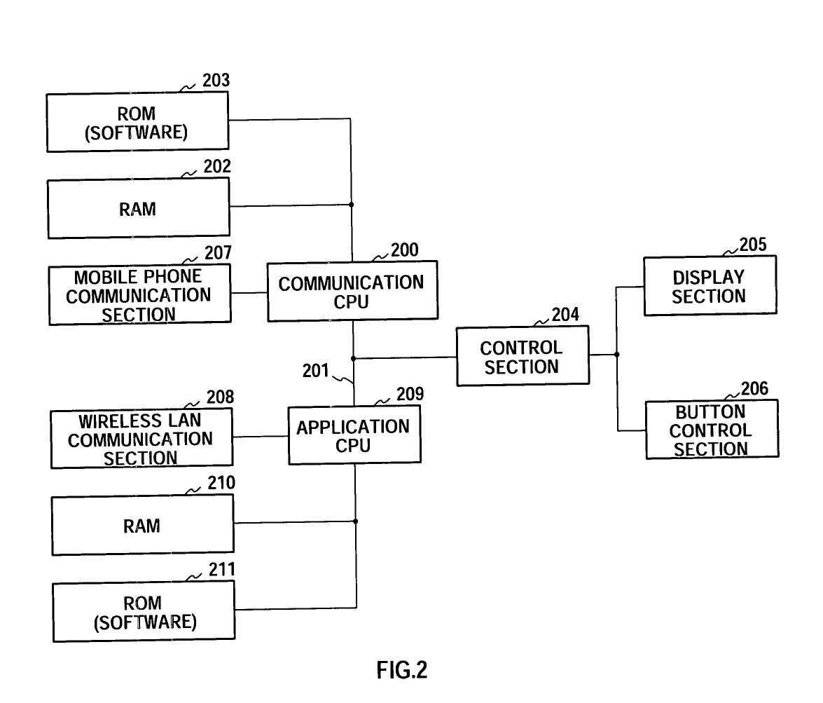

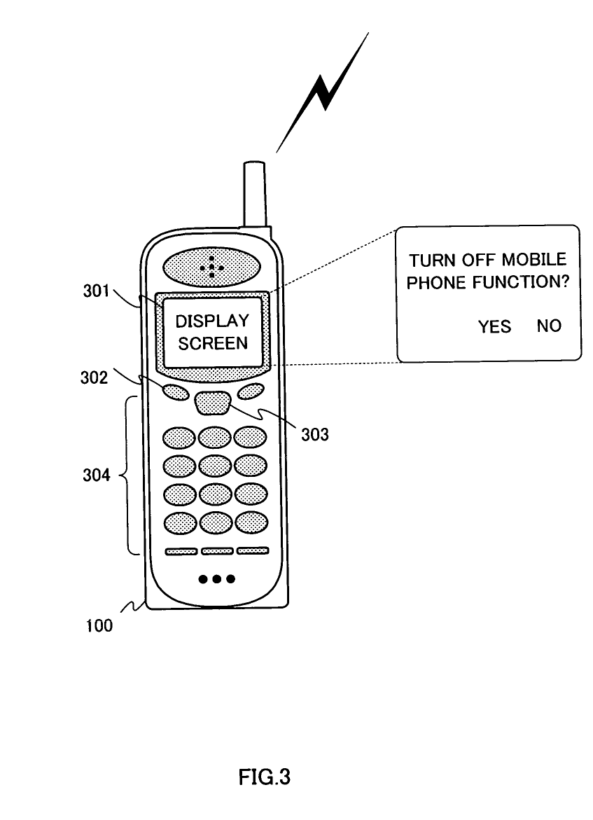

In FIG. 1, a case is shown in which radio dual terminal 100 present only in a mobile phone area 103 enters a wireless LAN area 104. The detailed configuration of this radio dual terminal 100 is as shown in FIG. 2 and FIG. 3, for example.

FIG. 2 is a block diagram showing the internal configuration of radio dual terminal 100 shown in FIG. 1. As shown in FIG. 2, radio dual terminal 100 shown in FIG. 1 has, for example, a communication CPU 200 that controls a mobile phone communication section 207, RAM 202 that is connected to communication CPU 200 and is used for various kinds of computation and data storage, and so forth, ROM 203 in which various kinds of programs are stored, a display section 205 that performs various kinds of display, a button control section 206 that performs control of various kinds of operating buttons provided on an operation section, a control section 204 composed of special-purpose semiconductor integrated circuitry, a mobile phone communication section 207 that implements communication by means of a mobile phone, and an application CPU 209 that controls a wireless LAN communication section 208. Connected to application CPU 209 are wireless LAN communication section 208 that implements communication by means of a wireless LAN, RAM 210 used for various kinds of computation and data storage, and so forth, and ROM 211 in which various application programs are stored. Communication CPU 200, control section 204, and application CPU 209 are connected via a bus 201. Communication CPU 200 and application CPU 209 may be integrated as one.

FIG. 3 is a drawing showing a sample external configuration of radio dual terminal 100 shown in FIG. 1, and a sample inquiry message display prompting the user to perform an operation to turn off the mobile phone function. In FIG. 3, a display screen 301, and various operating buttons 304 including a power button 302 and selection button 303, are located on the operation section of radio dual terminal 100.

Various kinds of display are performed on display screen 301, and in this embodiment an inquiry message “Turn off mobile phone function?”, a “YES” button that confirms affirmative intent, and a “NO” button that confirms negative intent, are displayed when radio dual terminal 100 enters wireless LAN area 104. In response to this message, the user manipulates selection button 303 and selects the “YES” button to indicate affirmative intent, or manipulates selection button 303 and selects the “NO” button to indicate negative intent. When the user operates any of the various operating buttons 304 after indicating affirmative intent, only the mobile phone function is turned off.

When radio dual terminal 100 enters wireless LAN area 104, application CPU 209 issues a “Turn off mobile phone function?” inquiry message output directive and a button control directive. If the user gives an affirmative intent indication, control section 204 reports this to the communication CPU, and only the mobile phone function is turned off.

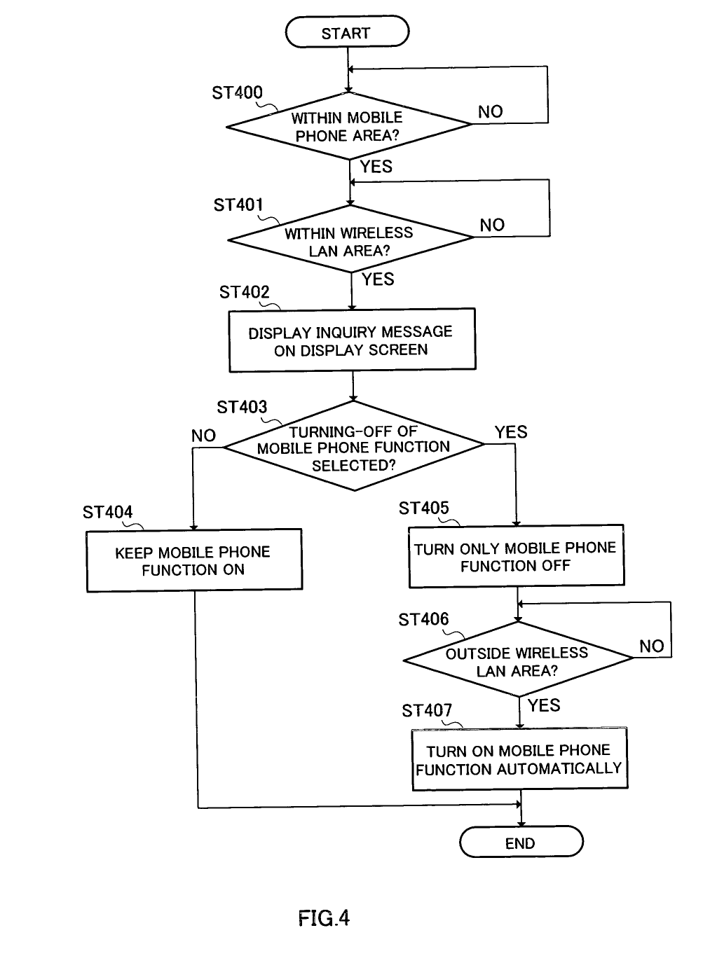

Next, radio communication function control operations according to this embodiment of radio dual terminal 100 configured as described above will be explained, following FIG. 4 and referring to FIG. 1 through FIG. 3. FIG. 4 is a flowchart that explains the radio communication function control operations of radio dual terminal 100 shown in FIG. 1.

In FIG. 4, when radio dual terminal 100 is outside mobile phone area 103, a power consumption reduction mode is entered in which confirmation of the user's intent and turning-off of power within a specified time are repeated, in the same way as with a normal mobile phone. In this process, mobile phone communication section 207 performs a channel scan when power is turned on within a short time, and determines whether or not radio dual terminal 100 has entered mobile phone area 103 (step ST400).

If radio dual terminal 100 has entered mobile phone area 103 (step ST400: YES), use of the mobile phone function becomes possible, and it is determined whether or not wireless LAN area 104 has been entered based on the reception sensitivity of wireless LAN radio waves input from wireless LAN communication section 208, for instance (step ST401).

If wireless LAN area 104 has been entered (step ST401: YES), application CPU 209 issues a display directive and button control directive to control section 204, as illustrated in FIG. 3. Display section 205 displays a “Turn off mobile phone function?” inquiry message, a “YES” button, a “NO” button, and an “OK” button (not shown), on display screen 301 (step ST402), and confirms the user's intent (step ST403). Control section 204 determines the position of each button, and display section 205 displays the position of each button accordingly.

If the user does not select turning-off of the mobile phone function (mobile phone communication section 207) (step ST403: NO), control section 204 notifies communication CPU 200 that the mobile phone function (mobile phone communication section 207) is to be kept in the on state even though wireless LAN area 104 has been entered (step ST404). On the other hand, if the user selects turning-off of the mobile phone function (mobile phone communication section 207) (step ST403: YES), on confirming the user's button operation, control section 204 sets a flag indicating “mobile phone OFF,” and notifies communication CPU 200 that the mobile phone function (mobile phone communication section 207) is to be turned off (step ST405). At this time, communication CPU 200 begins an operation whereby mobile phone communication section 207 is turned off (or placed in a sleep state) in accordance with the flag set by control section 204.

In a radio dual terminal 100 in which only the wireless LAN function (wireless LAN communication section 208) has come to be in the on state in this way, wireless LAN communication section 208 monitors the wireless LAN radio wave reception sensitivity, and determines whether or not that radio dual terminal 100 has stopped continuously within wireless LAN area 104 (step ST406). If radio dual terminal 100 exits wireless LAN area 104, or if the radio wave reception strength deteriorates (step ST406: YES), application CPU 209 checks the control section 204 flag, and if mobile phone communication section 207 has been turned off, changes the control section 204 flag and issues a directive to communication CPU 200 to turn on the mobile phone function (mobile phone communication section 207) (step ST407).

In the period until radio dual terminal 100 enters wireless LAN area 104 (step ST401: NO) when within mobile phone area 103 (step ST400: YES), and when radio dual terminal 100 exits wireless LAN area 104 while the mobile phone function is off (step ST406: YES), it is also possible to confirm the user's intent by asking the user whether or not the wireless LAN function (wireless LAN communication section 208) is to be turned off, and turn off the wireless LAN function (wireless LAN communication section 208) in response to a button operation by the user.

As described above, not only can power-off processing be performed by means of user involvement only when outside a mobile phone area, but also the mobile phone function only can be turned off by prompting the user to perform an operation to turn off the mobile phone function when a wireless LAN area is entered, even when within a mobile phone area, thereby enabling a reduction in power consumption to be achieved even when within a wireless LAN area. Also, the turned-off mobile phone function is turned on automatically when the wireless LAN area is exited, enabling mobile phone communication outside the wireless LAN area.

A first aspect of a radio communication terminal apparatus of the present invention has both a mobile phone function that performs communication via a mobile phone system and a wireless LAN function that performs communication via a wireless LAN system, and employs a configuration comprising: a determination section that determines whether or not the terminal has entered a wireless LAN area; a display section that, when it is determined by the determination section that the terminal has entered a wireless LAN area, displays a message inquiring whether or not the mobile phone function is to be turned off; and a control section that places the mobile phone function in an off state or sleep state in response to a button operation in response to the inquiry display.

According to this configuration, the mobile phone function only can be turned off or placed in a sleep state when within a wireless LAN area, enabling a reduction in power consumption to be achieved.

A second aspect of a radio communication terminal apparatus of the present invention employs a configuration wherein, in a radio communication terminal apparatus of the above-described first aspect, the control section turns off the mobile phone function in response to the button operation after the inquiry display.

According to this configuration, when within a wireless LAN area, an arbitrary button can be used as a directive button that turns off only the mobile phone function.

A third aspect of a radio communication terminal apparatus of the present invention employs a configuration wherein, in a radio communication terminal apparatus of the above-described first aspect, when the mobile phone function is turned off, the mobile phone function is turned on automatically by the control section when the determination section determines that the terminal has exited the wireless LAN area, or determines that the radio wave reception strength has deteriorated.

According to this configuration, the mobile phone function can be used when a wireless LAN area is exited, enabling the communication function to be maintained without interruption.

A fourth aspect of a radio communication function control method of the present invention is a radio communication function control method in a radio communication terminal apparatus that has both a mobile phone function that performs communication via a mobile phone system and a wireless LAN function that performs communication via a wireless LAN system, wherein a message inquiring as to whether or not the mobile phone function is to be turned off is displayed on a display screen upon entry in a wireless LAN area, and the mobile phone function is turned off or placed in a sleep state in response to a directive in response to the inquiry display.

According to this method, the mobile phone function only can be turned off or placed in a sleep state when within a wireless LAN area, enabling a reduction in power consumption to be achieved.

According to a fifth aspect of a radio communication function control method of the present invention, in a radio communication function control method of the above-described fourth aspect, the turned-off mobile phone function is turned on automatically when a wireless LAN area is exited.

According to this method, the mobile phone function can be used when a wireless LAN area is exited or when the radio wave reception strength deteriorates, enabling the communication function to be maintained without interruption.

The present application is based on Japanese Patent Application No. 2004-071618 filed on Mar. 12, 2004, entire content of which is expressly incorporated herein by reference.

### INDUSTRIAL APPLICABILITY

The present invention is suitable for reducing the power consumption of a radio communication terminal apparatus that has both a function for communication via a mobile phone system (a mobile phone function) and a function for communication via a wireless LAN system (a wireless LAN function).

1. A radio communication terminal apparatus that has both a mobile phone function that performs communication via a mobile phone system and a wireless LAN function that performs communication via a wireless LAN system, comprising:
a determination section that determines whether or not the terminal has entered a wireless LAN area;
a display section that, when it is determined by the determination section that the terminal has entered a wireless LAN area, displays a message inquiring as to whether or not the mobile phone function is to be turned off; and
a control section that places the mobile phone function in an off state or sleep state in response to a button operation in response to the inquiry display.

2. The radio communication terminal apparatus according to claim 1, wherein the control section turns off the mobile phone function in response to the button operation after the inquiry display.

3. The radio communication terminal apparatus according to claim 1, wherein, when the mobile phone function is turned off, the control section automatically turns on the mobile phone function when it is determined by the determination section that the terminal has exited a wireless LAN area, or it is determined that the radio wave reception strength has deteriorated.

4. A radio communication function control method in a radio communication terminal apparatus that has both a mobile phone function that performs communication via a mobile phone system and a wireless LAN function that performs communication via a wireless LAN system, wherein a message inquiring as to whether or not the mobile phone function is to be turned off is displayed on a display screen upon entry in a wireless LAN area, and the mobile phone function is turned off or placed in a sleep state in response to a directive in response to the inquiry display.

5. The radio communication function control method according to claim 4, wherein a mobile phone function that has been turned off or placed in a sleep state is turned on when a wireless LAN area is exited.
